(19) United States
(12) Patent Application Publication
(10) Pub. No.: US 2011/0235185 A1
(43) Pub. Date: Sep. 29, 2011

(54) Head-up display apparatus

(75) Inventor: Naohito Kanamori, Yokkaichi-city (JP)

(73) Assignee: DENSO CORPORATION, Kariya-city (JP)

(21) Appl. No.: 13/065,442

(22) Filed: Mar. 22, 2011

(30) Foreign Application Priority Data
Mar. 26, 2010 (JP) 2010-73372

(51) Int. Cl. G02B 27/01

(52) U.S. Cl. 359/630

(57) ABSTRACT

A head-up display apparatus includes an image output device and an optical system. The optical system includes a first and second optical members. The first optical member receives the image from the image output device. The second optical member receives the image from the first optical member and projects the image to a vehicle windshield. The second optical member has a position changer that rotates the second optical member to change an optical path thereof relative to the windshield to change a projection position of the image on the windshield. The first optical member has an adjuster that changes a position of the first optical member in order to adjust an optical path thereof relative to the second optical member to adjust the optical path of the second optical member.

### CROSS REFERENCE TO RELATED APPLICATION

This application is based on and incorporates herein by reference Japanese Patent Application No 2010-73372 filed on Mar. 26, 2010.

### BACKGROUND OF THE INVENTION

1. Field of the Invention

The present invention relates to a head-up display apparatus mounted to a mobile unit; such as a vehicle.

2. Description of Related Art

A head-up display apparatus (hereinafter, referred to as an HUD apparatus) is know to have an image output device and an optical system. The image output device is configured to output an image, and the optical system projects the image, which is outputted by the image output device, on the windshield of the vehicle to display a virtual image observable from inside the vehicle (JP4336245, JP-A-2009-132221).

JP4336245 describes an HUD apparatus that has an adjustment mechanism for adjusting the position of the image output device itself. In the HUD apparatus having the above adjustment mechanism, when there is error made during the assembly of the HUD apparatus to the instrument panel, and thereby the display of the virtual image is inclined on the surface of the instrument panel, the inclination of the virtual image is adjustable by adjusting the position of the image output device by using the adjustment mechanism.

Also, JP-A-2009-132221 describes another HUD apparatus that has a reflecting mirror and a position changer. The reflecting mirror projects images on the windshield. The position changer is provided to the reflecting mirror and rotates the reflecting mirror about the rotation axis in order to adjust the projection position of the image on the windshield. The HUD apparatus having the position changer is capable of displacing the position of the virtual image as required by the occupant by changing the projection position.

Because the HUD apparatus displays the virtual image by projecting the image on the windshield, the erroneous inclination or deformation of the displayed virtual image need to be prevented when the virtual image is displayed. Thus, in general, the optical system is designed in accordance with the shape of the windshield of the vehicle, to which the HUD apparatus is mounted, and with the position relation between the HUD apparatus and the windshield.

In general, the shape of the windshield is curved. Furthermore, the curvature of the surface is not uniform, and varies partially. For example, the curvature of the surface in the left-right direction of the vehicle becomes greater toward the lateral ends. As above, the form of the surface of the windshield is different at different positions, and thus, the surface of the windshield has a complicated shape.

As a result, in a case, where there is dimension error of the windshield, or where error made during the assembly of the windshield to the body, the optical path of the optical system relative to the windshield erroneously shifts even when the optical system is appropriately designed and manufactured in accordance of the shape of the windshield. Thereby, the displayed virtual image may be inclined or deformed, and thus the display condition of the virtual image deteriorate accordingly.

The size of the windshield is substantially large compared with the components of the HUD apparatus. Accordingly, the dimension error of the windshield is substantially large compared with the dimension error of the components of the HUD apparatus. Also, the assembly error of the windshield is substantially large compared with the assembly error of the components of the HUD apparatus. As above, there is a limit in reducing the dimension error of the windshield and the assembly error of the windshield to the body.

Thus, the adjustment mechanism of the image output device of the HUD apparatus of JP4336245 adjusts the display condition of the virtual image. However, when the image output device is actually provided with the adjustment mechanism, the structure of the image output device become complicated. Because the image output device includes an electronic equipment, such as a control circuit for controlling the image display, change in the structure of the image output device caused by the provision of the adjustment mechanism is complicated. Also, the display position of the image on the screen may be changed. However, in order to change the above position, a display region in the screen has to be enlarged, and thereby causing the increase in size of the image display device.

According to the position changer of JP-A-2009-132221, the rotational position of the reflecting mirror is changed in order to change the projection position of the image on the windshield. When the rotational position of the reflecting mirror is change, the optical path of the reflecting mirror relative to the windshield is changed accordingly. As a result, the display condition of the virtual image displayed on the windshield may be erroneously changed depending on the shape of the windshield or on the assembly state of the windshield. In other words, it may be possible to adjust the display condition of the virtual image by rotating the reflecting mirror through the position changer.

However, in general, the display range, in which the virtual image is to be displayed, changes depending on regulation and the shape of the windshield. Thus, the reflecting mirror is limited to be rotatable within a predetermined rotation angle. Due to the above, even though the display condition of the virtual image is adjustable by rotation of the reflecting mirror, there may be a case, where the display condition of the virtual image is not sufficiently adjustable only by the adjustment of the reflecting mirror within the movable, range depending on the dimension error or the assembly error of the windshield. Also, even when the display condition of the virtual image is adjusted by the adjustment of the reflecting mirror within the movable range, the display position of the virtual image may be positioned out of the position preferred by the occupant. In the above, it is impossible to adjust the display condition of the virtual image by rotating the reflecting mirror disadvantageously.

### SUMMARY OF THE INVENTION

The present invention is made in view of the above disadvantages. Thus, it is an objective of the present invention to address at least one of the above disadvantages.

To achieve the objective of the present invention, there is provided a head-up display apparatus that includes an image output device and an optical system. The image output device outputs an image, and the optical system projects the image outputted from the image output device to a windshield of a vehicle in order to display a virtual image within the vehicle. The optical system includes a first optical member and a second optical member. The first optical member receives the image outputted from the image output device and reflects the received image. The first optical member has an optical path, along which the image reflected by the first optical member travels. The second optical member receives the image reflected by the first optical member and projects the received image to the windshield by reflecting the received image. The second optical member has an optical path, along which the image reflected by the second optical member travels. The second optical member has a position changer that rotates the second optical member within a predetermined rotation angle in order to change the optical path of the second optical member relative to the windshield such that a projection position of the image reflected by the second optical member on the windshield is changed. The first optical member has an adjuster that changes a position of the first optical member in order to adjust the optical path of the first optical member relative to the second optical member such that the optical path of the second optical member relative to the windshield is adjusted.

### BRIEF DESCRIPTION OF THE DRAWINGS

The invention, together with additional objectives, features and advantages thereof, will be best understood from the following description, the appended claims and the accompanying drawings in which:

FIG. 1 is a schematic configuration illustrating a state, where a head-up display apparatus according to the first embodiment of the present invention is mounted to a vehicle;

FIG. 2 is a perspective view of a plane mirror observed from a side of the plane mirror opposite from a reflective surface;

FIG. 3 is a side view of a magnifying mirror;

FIG. 4 is a cross-sectional view of a head-up display apparatus according to the second embodiment of the present invention;

FIG. 5 is a flow chart illustrating a procedure for adjusting a display condition of a virtual image when a position changer is operated; and

FIG. 6 is a relation chart illustrating a relation between a rotation angle of the magnifying mirror and a rotation angle of the plane mirror, the chart being used for improving the display condition of the virtual image.

### DETAILED DESCRIPTION OF PREFERRED EMBODIMENTS

Multiple embodiments of the present invention will be described below with reference to accompanying drawings. It should be noted that configurations similar to each other in different embodiments will be indicated by the same numerals, and thereby redundant explanation will be omitted in the specification.

### First Embodiment

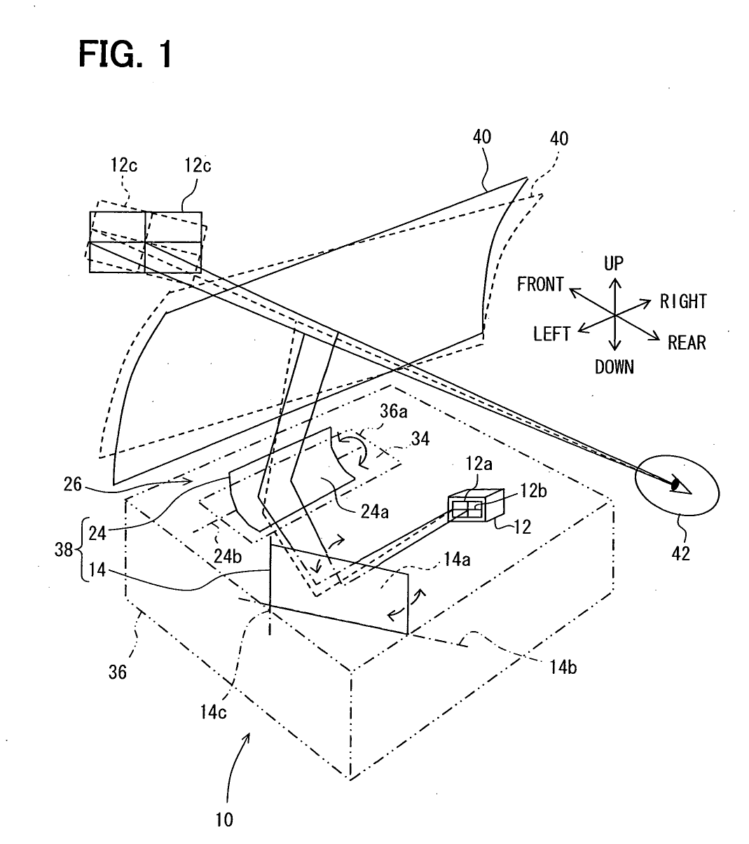

The first embodiment of the present invention will be described with reference to the accompanying drawings. FIG. 1 is a schematic configuration illustrating a state, where a head-up display apparatus (HUD apparatus) according to the first embodiment of the present invention is mounted to a vehicle.

As shown in FIG. 1, an HUD apparatus 10 is provided within an inner space of an instrument panel (not shown) that inwardly projects from a lower end of a front windshield 40 in a passenger compartment. The HUD apparatus 10 has an image output device 12, a plane mirror 14, a magnifying mirror 24, and a cover 34. The above components are received or attached to a housing 36.

The image output device 12 is received by the housing 36, and has a screen 12a that displays various information sets (image) 12b. In the present embodiment, the image output device 12 is provided at a position such that the screen 12a faces in a left-right direction (transverse direction) of the vehicle. Light of the image 12b emitted by the screen 12a travels in a direction from the right side to the left side of the vehicle.

In the present embodiment, the image output device 12 employs a liquid crystal display device. The liquid crystal display device includes a dot matrix TFT transparent liquid crystal panel, a backlight, and a control circuit. The TFT transparent liquid crystal panel forms the screen 12a by using multiple liquid crystal pixels arranged in a two-dimensional array. The backlight is provided on a rear side of the liquid crystal panel and illuminates the panel from the rear side. The control circuit controls transmissibility of liquid crystal pixel of the liquid crystal panel and turns on and off the backlight.

The plane mirror 14 is received within the housing 36, and receives light of the image 12b emitted (outputted) by the image output device 12. Then, the plane mirror 14 reflects the light of the image 12b toward the magnifying mirror 24. Thus, the plane mirror 14 leads the reflected light of the image 12b to the magnifying mirror 24. The plane mirror 14 is provided in a light passage, through which light travels from the image output device 12 to the magnifying mirror 24. The plane mirror 14 is provided such that a reflective surface 14a of the plane mirror 14 faces toward the screen 12a of the image output device 12 and a reflective surface 24a of the magnifying mirror 24. In the present embodiment, the plane mirror 14 is formed into a rectangular shape. The long side of the rectangular shape of the plane mirror .14 extends in an up-down direction of the vehicle, and the short side of the rectangular shape of the plane mirror 14 extends in a horizontal direction orthogonal to the up-down direction of the vehicle. Also, a rotation axis 14b extends along the lower long side of the plane mirror 14, and a rotation axis 14c extends along a short side of the plane mirror 14 adjacent the magnifying mirror 24.

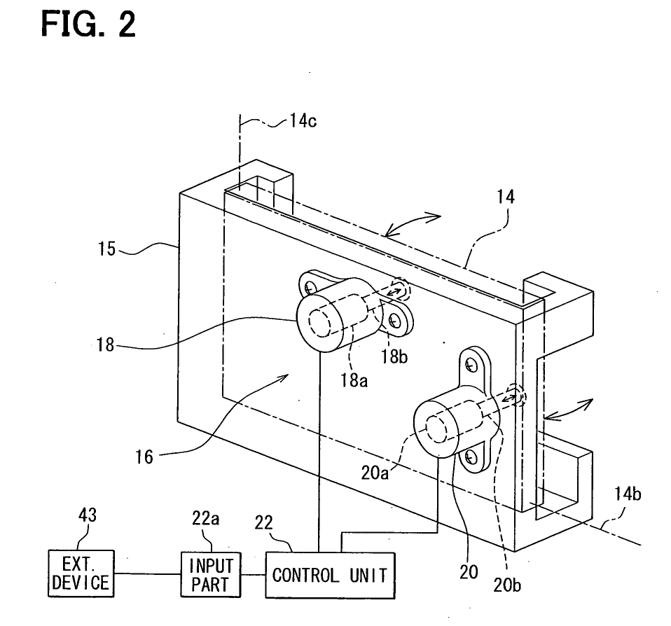

FIG. 2 is a perspective view of the plane mirror 14 observed from a side of the plane mirror 14 opposite from the reflective surface 14a that faces toward the, image output device 12 and the magnifying mirror 24. An adjuster 16 is provided at a position opposite from the reflective surface 14a of the plane mirror 14 and is configured to change a position of the reflective surface 14a. The adjuster 16 changes a rotational position of the reflective surface 14a in order to cause the plane mirror 14 to rotate about the rotation axes 14b, 14c that extend in two different directions as shown in FIG. 2. The adjuster 16 has two drive portions 18, 20, a control unit 22, an electric motor 18a, and a conversion mechanism 18b. The control unit 22 drives each of the drive portions 18, 20. The drive portion 18 rotates the plane mirror 14 about the rotation axis 14b. The conversion mechanism 18b converts turning force of the electric motor 18a to a linear motion. The drive portion 18 is provided near the long side of the plane mirror 14 opposite from the other long side, to which the rotation axis 14b is provided.

A drive portion 20 includes an electric motor 20a and a conversion mechanism 20b. The electric motor 20a rotates the plane mirror 14 about the rotation axis 14c, and the conversion mechanism 20b converts turning force of the electric motor 20a into a linear motion. The drive portion 20 is provided near the short side of the plane mirror 14 opposite from the other short side, to which the rotation axis 14c is provided.

The electric motor 18a and the electric motor 20a employed for the drive portion 18 and the drive portion 20, respectively, for example, may be stepping motors. The drive portion 18 and the drive portion 20 are attached to an attachment base 15 that supports the plane mirror 14. The attachment base 15 is configured to rotate the plane mirror 14 about the rotation axes 14b, 14c. The drive portion 18 and the drive portion 20 are attached to the rear side of the attachment base 15 (opposite from the plane mirror 14), and the electric motors 18a and 20a are operated such that the conversion mechanisms 18b and 20b push the plane mirror 14 from the rear side toward the front side. An urging member (not shown), such as a leaf spring, for urging the plane mirror 14 toward the rear side of the attachment base 15 is provided on a side of the attachment base 15 adjacent the plane mirror 14 between the attachment base 15 and the plane mirror 14.

As shown in FIG. 2, the control unit 22 has an input part 22a that receives a drive signal from an exterior device 43. The control unit 22 controls each of the drive portions 18, 20 in accordance with the drive signal received through the input part 22a. When each of the drive portions 18, 20 is controlled, the rotational position of the reflective surface 14a is changed, and thereby a reflection angle of the image 12b, by which angle light of the image 12b incident to the reflective surface 14a reflects off the surface 14a, is changed accordingly. As a result, an output-side optical path of the plane mirror 14 relative to the magnifying mirror 24 is changed. In the above, light of the image 12b reflected by the reflective surface 14a of the plane mirror 14 travels along the output-side optical path of the plane mirror 14, for example.

The reflective surface 24a of the magnifying mirror 24 has a recess shape, and the magnifying mirror 24 is received within the housing 36. The magnifying mirror 24 reflects light of the image 12b reflected by the plane mirror 14, and magnifies the image 12b reflected by the plane mirror 14 to project the magnified image on the front windshield 40. The image 12b magnified by the magnifying mirror 24 is projected on the front windshield 40 through an opening portion 36a of the housing 36. The image 12b projected on the front windshield 40 is reflected to reach an eye-range 42 (or range of sight) of the occupant of the vehicle. As a result, the occupant visually recognizes a virtual image 12c of the image 12b at an imaginary position on the other side of the front windshield 40 remote from the occupant. In the present embodiment, the magnifying mirror 24 is located at a position such that the reflective surface 24a faces toward the vehicle rear side to output light of the image 12b, which is received from the plane mirror 14, toward the front windshield 40.

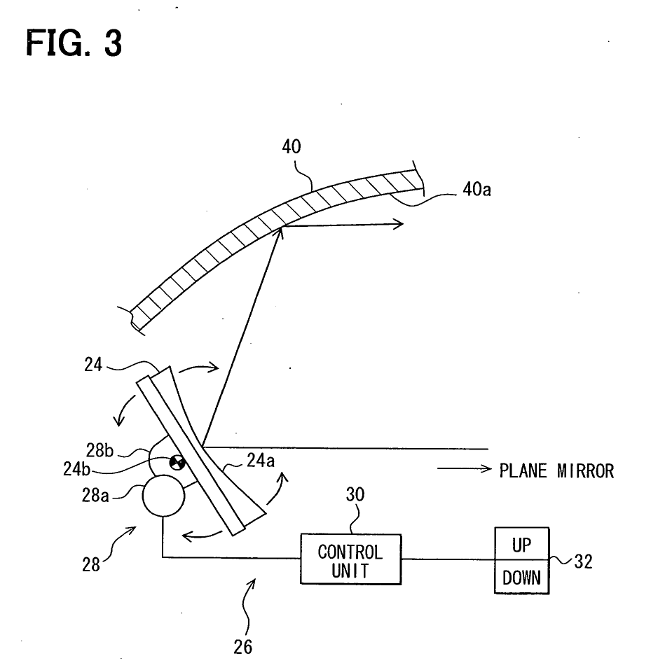

FIG. 3 is a side view of the magnifying mirror 24. A position changer 26 is provided on a side of the magnifying mirror 24 opposite from the reflective surface 24a. The position changer 26 rotates the magnifying mirror 24 about a rotation axis 24b that extends in the left-right direction of the vehicle. As above, the position changer 26 changes the angle of the magnifying mirror 24 relative to the front windshield 40, and thereby changing an output-side optical path of the magnifying mirror 24 relative to the front windshield 40. The position changer 26 is configured to change a display position of the virtual image 12c in accordance with the preference of the occupant. Also, in the above, light of the image 12b reflected by the reflective surface 24a of the magnifying mirror 24 travels along the output-side optical path of the magnifying mirror 24.

In the present embodiment, the position changer 26 causes the magnifying mirror 24 to rotate about the rotation axis 24b within a limited predetermined angular range. The predetermined angular range is determined based on the display position of the virtual image 12c on the windshield 40. The display position of the virtual image 12c is determined based on a regulation and based on the shape of the front windshield 40.

The position changer 26 includes. a drive portion 28, a control unit 30 and an operation switch 32. The control unit 30 controls the drive portion 28, and the operation switch 32 is operated by the occupant. The drive portion 28 includes an electric motor 28a and a transmission mechanism 28b that transmits turning force of the electric motor 28a to the rotation axis 24b.

The operation switch 32 is provided at a position, for example, at the instrument panel, such that the occupant is capable of operating the operation switch 32. The operation switch 32 outputs a command signal in accordance with the operation of the occupant to the control unit 30. The operation switch 32 has an “UP” button and a “DOWN” button, and transmits the different command signal to the control unit 30 depending on the operation of the “UP” button or the “DOWN” button.

For example, when the occupant operates the “UP” button, the operation switch 32 transmits the corresponding command signal (UP command signal) to the control unit 30. Then, the control unit 30 controls the electric motor 28a in order to rotate the magnifying mirror 24 about the rotation axis 24b such that the projection position of the image 12b on the front windshield 40 is displaced in a direction upward of the vehicle.

The cover 34 is made of a translucent resin material, and is provided to cover the opening portion 36a of the housing 36. The cover 34 prevents dusts from entering into the housing 36 through the opening portion 36a.

The image output device 12, the plane mirror 14, and the magnifying mirror 24 are provided on an optical path indicated by, a solid line in FIG. 1. Because the components 12, 14 and 24 are provided on the predetermined optical path as above, light outgoing (emitted) from the image 12b displayed on the image output device 12 travels along the optical path, and thereby the display condition of the virtual image 12c indicated by the solid line in FIG. 1 becomes good. Because the output-side optical path of the magnifying mirror 24 to the front windshield 40 and the output-side optical path of the plane mirror 14 to the magnifying mirror 24 generally coincide with the regular optical path shown in FIG. 1, the display condition of the virtual image 12c becomes good.

The front windshield 40 will be describe below. The front windshield 40 has a reflective surface 40a, which faces the passenger compartment for reflecting light. The reflective surface 40a of the front windshield 40 curves such that the curved part projects toward an exterior of the passenger compartment. The reflective surface 40a of the front windshield 40 has a curvature that is not uniform and varies at different position of the front windshield 40. Specifically, a curved surface of the reflective surface 40a is symmetrical in a left-right direction (lateral direction) relative to a lateral center of the vehicle. Also, the curved surface of the reflective surface 40a is formed such that the curvature of the reflective surface 40a becomes greater with the increase of the distance from the lateral center. Also, the front windshield 40 is provided to the body to be inclined toward the occupant as shown in FIG. 1 and FIG. 3. Furthermore, the reflective surface 40a of the front windshield 40 is curved in an up-down direction of the vehicle. As described above, the reflective surface 40a of the front windshield 40 has a substantially complicated shape.

As above, the HUD apparatus 10 causes the image 12b outputted from the apparatus 10 to reflect off the front windshield 40, and causes the occupant to visually recognize the reflected image 12b as the virtual image 12c. Thereby, when the optical path of an optical system 38, which includes the plane mirror 14 and the magnifying mirror 24 of the HUD apparatus 10, relative to the front windshield 40 is erroneously shifted, erroneous phenomenon, such as a the slanted virtual image 12c, may occur as shown by a dashed line in FIG. 1. As a result, the accuracy in dimension of the front windshield 40 and the accuracy of assembly of the front windshield 40 are very important.

However, the front windshield 40 is substantially large compared with the plane mirror 14 or the magnifying mirror 24, and thereby the dimension error of the front windshield 40 is substantially larger than those of the plane mirror 14 and the magnifying mirror 24. Also, error made during the assembly of the front windshield 40 to the body is substantially larger than error made during the assembly of the plane mirror 14 and the magnifying mirror 24 to the housing 36. As a result, even when the plane mirror 14 and the magnifying mirror 24 are accurately assembled to the housing 36 in order to accurately position the optical path within the optical system 38, the dimension error or the assembly error of the front windshield 40 may erroneously shift the optical path of the optical system 38 relative to the front windshield 40, and thereby the display condition of the virtual image 12c may deteriorate.

The change in the rotational position of the magnifying mirror 24 may change the display condition of the virtual image 12c. The above is caused because the output-side optical path of the magnifying mirror 24 relative to the front windshield 40 changes. In other words, by causing the position changer 26 to rotate the magnifying mirror 24, it may be possible to avoid the deterioration of the display condition of the virtual image 12c caused by the dimension error or the assembly error of the front windshield 40.

However, because the movable range of the magnifying mirror 24 is limited as above, and even the rotation of the magnifying mirror 24 may not be able to adjust the display condition of the virtual image 12c. Also, even in another case, where the display condition of the virtual image 12c is adjusted with the change of the magnifying mirror 24 within the movable range, the display position of the virtual image 12c may be displaced from a wanted position of the occupant. In the above case, it is impossible to adjust the display condition of the virtual image by rotating the magnifying mirror 24.

In the present embodiment, in order to adjust the above display condition deteriorated by the dimension error or the assembly error of the front windshield 40, the plane mirror 14 is provided with the adjuster 16. The adjuster 16 is configured to change the rotational position of the reflective surface 14a of the plane mirror 14 in order to adjust the display condition of the virtual image 12c such that the optical path of the optical system 38 relative to the front windshield 40 is adjusted. As a result, the display condition of the virtual image 12c is adjusted.

A procedure for adjusting the display condition of the virtual image 12c will be described. An adjusting process is started in a state, where the HUD apparatus 10 and the front windshield 40 are provided at predetermined positions of the body. The present embodiment will describe a case, where the front windshield 40 is erroneously assembled to a position, which is out of a regular position, and which is shown by a dashed line of FIG. 1. The adjusting process is executed, for example, in a factory or a repair shop (service station).

Firstly, an operator connects the exterior device 43 to the adjuster 16. Specifically, as shown in FIG. 2, the operator connects a signal wire of the exterior device 43 with the input part 22a of the control unit 22 of the adjuster 16 such that the drive signal from the exterior device 43 is inputted into the input part 22a of the control unit 22. The exterior device 43 is temporarily used in the adjustment of the display condition of the virtual image 12c, and operates the drive portions 18, 20 of the adjuster 16.

Next, the HUD apparatus 10 is started to project the image 12b on the front windshield 40. The image 12b displayed in the image output device 12 during the adjustment is a test image, and is a static image having a rectangular frame with two intersecting line segments that pass through a center of the rectangular frame as shown in FIG. 1. Also, in the above state, the position changer 26 has not been started. In the adjusting process, the position changer 26 will not be started until the adjusting process by the adjuster 16 has ended. During the adjusting process, the rotational position of the magnifying mirror 24 is fixed at a dedicated position for the adjusting process, or at a reference position. In the present embodiment, the adjuster 16 independently work for the position changer 26 during the adjusting process.

Because the front windshield 40 is attached at a position that is out of the regular position as shown by a dashed line, the optical path of the optical system 38 relative to the front windshield 40 is erroneously shifted, and thereby an actually-displayed virtual image 12c shown by the dashed line is erroneously angled relative to a regular virtual image 12c shown by a solid line.

Subsequently, the operator operates the exterior device 43 while the operator visually checking the display condition of the virtual image 12c in order to correct the erroneous inclination of the actually-displayed virtual image 12c. When the operator operates the exterior device 43, the exterior device 43 transmits, to the control unit 22, the drive signals for driving the drive portions 18, 20.

When the control unit 22 receives the drive signal, the control unit 22 controls the electric motor 18a, 20a of each of the drive portions 18, 20 based on the drive signal to change the rotational position of the reflective surface 14a of the plane mirror 14. Specifically, the adjuster 16 rotates the plane mirror 14 about at least one of the rotation axis 14b and the rotation axis 14c to change the rotational position of the reflective surface 14a.

When the rotational position of the reflective surface 14a of the plane mirror 14 changes, the output-side optical path of the plane mirror 14 relative to the magnifying mirror 24 is adjusted. Due to the above, the output-side optical path of the magnifying mirror 24 relative to the front windshield 40 is adjusted, and as a result, the erroneous inclination of the virtual image 12c is adjusted effectively. The operator keeps operating the exterior device 43 to control the adjuster 16 until the display condition of the virtual image 12c becomes substantially good. When the display condition of The virtual image 12c becomes substantially good, the operator detaches the exterior device 43 from the adjuster 16. When the operator detaches the exterior device 43 from the adjuster 16, the adjusting process is ended. After the above, the adjuster 16 does not operate, and thereby only the position changer 26 is operated by the operation of the operation switch 32 by the occupant.

In the present embodiment, as above, the plane mirror 14 is provided with the adjuster 16 that changes the rotational position of the reflective surface 14a to adjust the output-side optical path of the plane mirror 14 relative to the magnifying mirror 24. The adjuster 16 is capable of adjusting the display condition of the virtual image 12c even in a case, where the adjustment of the display condition of the virtual image 12c is impossible within the movable range of the magnifying mirror 24.

Also, the adjuster 16 is capable of adjusting the display condition of the virtual image 12c while the virtual image 12c is kept displayed at a position preferred by the occupant. The above is enabled because the position changer 26 adjusts the display condition of the virtual image 12c by rotating the magnifying mirror 24.

In addition, even when the dimension error or the assembly error of the front windshield 40 erroneously shifts the optical path of the optical system 38 relative to the front windshield 40, and thereby the display condition of the virtual image 12c deteriorates, the adjuster 16 is capable of adjusting the above erroneous shift of the optical path by using the plane mirror 14. As a result, without an intensive process of adjusting the position of the front windshield 40 relative to the body, it is possible to easily adjust the display condition of the virtual image 12c.

Furthermore, in the present embodiment, the adjuster 16 for adjusting the optical path is provided to the plane mirror 14 that has a relatively simple structure. As a result, it is possible to effectively reduced the cost of adding the adjuster 16 compared with a case, where the adjuster 16 is provided to the image output device 12 or to the magnifying mirror 24.

The image output device 12 has an electronic equipment, such as a circuit for executing the display control of the image 12b on the screen 12a. In a comparison case, where the adjuster 16 is provided to the image output device 12, the structure of the image output device 12 becomes very complicated, and thereby the cost of the HUD apparatus 10 would be widely increased. Also, similarly to the above, the magnifying mirror 24 is provided with the position changer 26 for changing the projection position of the image 12b on the front windshield 40. If the adjuster 16 is provided to the magnifying mirror 24 that already has the position changer 26, the structure of the magnifying mirror 24 would be very complicated, and thereby leading to the wide increase of the cost of the HUD apparatus 10. Due to the above reasons, by providing the adjuster 16 to the plane mirror 14 that only leads light of the image 12b to the magnifying mirror 24, it is possible to substantially reduce the cost of the HUD apparatus 10 compared with the case, where the adjuster 16 is provided to the image output device 12 or the magnifying mirror 24.

As described above, according to the present embodiment, it is possible to provide the HUD apparatus 10 that is capable of easily adjusting the display condition of the virtual image 12c even in a severe case, where the movable range of the magnifying mirror 24 that changes the projection position of the image 12b on the front windshield 40 is limited, and where the display condition of the virtual image 12c is not adjusted even when the rotational position of the magnifying mirror 24 is changed.

Also, in the present embodiment, the adjuster 16 has the drive portions 18, 20 and the input part 22a. Each of the drive portions 18, 20 changes the position of the reflective surface 14a of the plane mirror 14. The input part 22a is electrically connected with each of the drive portions 18, 20 and the exterior device 43 and receives the drive signals from the exterior device 43. When the input part 22a receives the drive signal from the exterior device 43, the electric motors 18a, 20a of the drive portions 18, 20 generate turning force for rotating the plane mirror 14 about the rotation axes 14b, 14c, respectively, in accordance with the drive signal. Because the adjuster 16 has the drive portions 18, 20 and the input part 22a, it is possible to remotely operate each of the drive portions 18, 20 of the adjuster 16 from outside the HUD apparatus 10. As a result, according to the present embodiment, it is possible to more easily execute the optical path adjusting process compared with a case, where adjusting process for adjusting the optical path of the optical system 38 is executed by using tools after removing the cover 34 of the HUD apparatus 10. Also, according to the present embodiment, it is possible to reduce the working hours.

The optical path adjusting process of the optical system 38 is executable after the front windshield 40 and the HUD apparatus 10 are assembled to the body, for example, in the factory or in the service station. As a result; the user of the vehicle does not necessarily have to adjust the optical path of the optical system 38.

In the present embodiment, the input part 22a of the adjuster 16 is temporarily connected with the exterior device 43 when the optical path adjusting process of the optical system 38 is executed. As a result, after the execution of the optical path adjusting process of the optical system 38, it is possible to detach the exterior device 43 from the HUD apparatus 10. Also, when the optical path adjusting process becomes required, the adjusting process is executable by attaching the exterior device 43 to the HUD apparatus 10. Therefore, it is not required to provide the HUD apparatus 10 with a dedicated apparatus to operate the adjuster 16, and thereby it is possible to suppress the increase in the cost of the HUD apparatus 10.

Also, in the present embodiment, the plane mirror 14 is configured to rotate about the rotation axes 14b and 14c that extend in different directions. As a result, it is possible to relatively flexibly adjust the direction, in which the reflective surface 14a of the plane mirror 14 faces. Thereby, an adjustable range of the optical path is increased, and thereby adjusting performance of the adjuster 16 is effectively improved.

In addition, in the present embodiment, the adjuster 16 is provided to the plane mirror 14. The plane mirror 14 has a substantially simple optical feature in contrast to a concave mirror or a convex mirror. In the present embodiment, because the adjuster 16 is provided to the plane mirror 14 having the simple optical feature, it is possible to easily adjust the optical path.

In the present embodiment, the adjuster 16 operates independently from the position changer 26 as above. The adjuster 16 is capable of adjusting the optical path of the magnifying mirror (second optical member) 24 relative to the windshield 40 in order to adjust the display condition of the virtual image 12c in a state, where the rotation angle position of the magnifying mirror 24 remains fixed. As a result, without replacement or reassembly of the windshield, it is possible to easily compensate the dimension error or the assembly error merely by operating the adjuster 16 to adjust the display condition of the virtual image 12c at the time of factory shipments or at the service station.

It should be noted that the plane mirror 14 of the present embodiment corresponds to a first optical member, and the magnifying mirror 24 corresponds to a second optical member.

### Second Embodiment

The second embodiment of the present invention will be described with accompanying drawings. The second embodiment is a modification of the HUD apparatus 10 of the first embodiment. The second embodiment is an example for adjusting the display condition of the virtual image 12c, which deteriorates when the position changer 26 is operated. Points different from the first embodiment will be mainly described below.

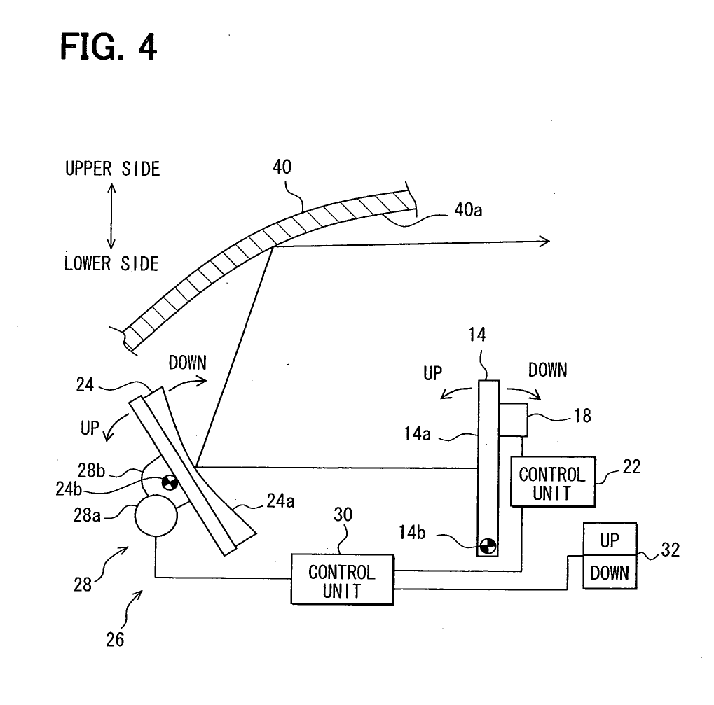

FIG. 4 is a cross-sectional view of the HUD apparatus 10 of the second embodiment. It should be noted that components shown in FIG. 4 are substantially similar to those of the HUD apparatus 10 of the first embodiment shown in FIG. 1. Also, the plane mirror 14 shown in FIG. 4 is observed in a direction of the rotation axis 14b in order to facilitate the description. The position relation between the magnifying mirror 24 and the plane mirror 14 in FIG. 4 is similar to the relation shown in FIG. 1. In contrast to the first embodiment, the adjuster 16 and the position changer 26 of the present embodiment are operated synchronously with each other.

When the position changer 26 is operated by the occupant through the operation of the operation switch 32, the magnifying mirror 24 rotates about the rotation axis 24b. For example, the occupant operates the “UP” button of the operation switch 32, the control unit 30 controls the drive portion 28 to rotate the magnifying mirror 24 in an UP direction indicated in FIG. 4. By the rotation of the magnifying mirror 24 in the UP direction (counterclockwise in FIG. 4), an angular relation between (a) the reflective surface 24a of the magnifying mirror 24 and (b) the reflective surface 40a of the front windshield 40 changes. As a result, the projection position of the image 12b magnified by the magnifying mirror 24 on the reflective surface 40a of the front windshield 40 is shifted toward the upper side of the vehicle.

In contrast, when the occupant operates the “DOWN” button of the operation switch 32, the control unit 30 controls the drive portion 28 to rotate the magnifying mirror 24 in a DOWN direction in FIG. 4. By the rotation of the magnifying mirror 24 in the DOWN direction (clockwise in FIG. 4), the angular relation between (a) the reflective surface 24a of the magnifying mirror 24 and (b) the reflective surface 40a of the front windshield 40 changes. As a result, the projection position of the image 12b magnified by the magnifying mirror 24 on the reflective surface 40a of the front windshield 40 is shifted toward the lower side of the vehicle.

As above, it is possible to change the position of the image 12b projected on the front windshield 40 to a certain position preferred by the occupant the occupant through the operation of the operation switch 32.

However, as is generally described in the first embodiment, the reflective surface 40a of the front windshield 40 has the curved shape. As a result, when the position changer 26 is operated, and thereby the angular relation between (a) the reflective surface 24a of the magnifying mirror 24 and (b) the reflective surface 40a of the front windshield 40 changes, the output-side optical path of the magnifying mirror 24 relative to the front windshield 40 may erroneously shifts. Thereby, the displayed virtual image 12c may be erroneously inclined.

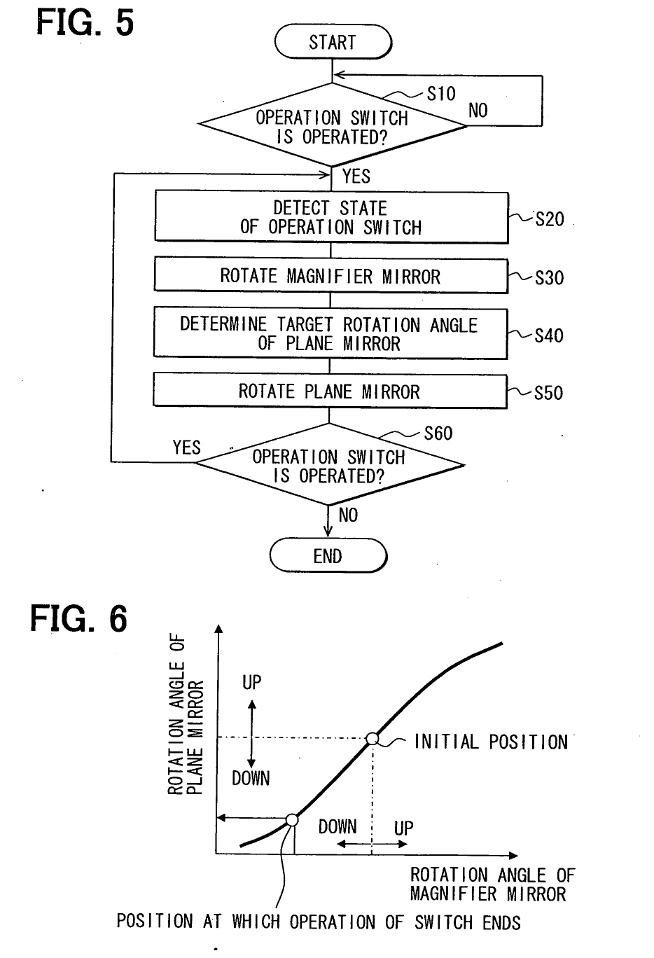

However, according to the second embodiment, it is possible to more accurately adjust the deteriorated display condition of the virtual image 12c by the adjuster 16 that operates synchronously with the operation of the position changer 26. The above procedure will be described with reference to FIGS. 5 and 6.

FIG. 5 is a flow chart illustrating a procedure of adjusting the display condition of the virtual image 12c in a case of the operation of the position changer 26. The control flow is started after the HUD apparatus 10 has been operated. In the present embodiment, the control unit 30 of the position changer 26 executes the control flow.

FIG. 6 is a relation chart illustrating a relation between (a) a rotation angle of the magnifying mirror 24 and (b) a rotation angle of the plane mirror 14, which chart is used to improve the display condition of the virtual image 12c. The rotation angles are measured relative to, for example, a horizontal plane of the vehicle. In FIG. 6, the rotation angle of the magnifying mirror 24 is measured about the rotation axis 24b, and the rotation angle of the plane mirror 14 is measured about the rotation axis 14b. In the present embodiment, a control flow is started based on an initial position in FIG. 6.

In the present embodiment, a certain case, in which the occupant operates the “DOWN” button of the operation switch 32, will be described.

At step S10 in FIG. 5, it is determined whether the occupant has operated the operation switch 32. Specifically, the above determination is made depending on whether the control unit 30 detects the command signal that is transmitted thereto by the operation switch 32 in accordance with the operational state of the switch 32.

When it is determined at step S10 that the operation switch 32 is operated, control proceeds to step S20. When it is determined that the operation switch 32 has not been operated, control returns to step S10.

At step S20, the state of the operation switch 32 is detected. In other words, the operation of the “UP” button or the “DOWN” button is detected at step S20. Specifically, the control unit 30 identifies the type of the command signal that is transmitted by the operation switch 32 to the control unit 30.

At step S30, the drive portion 28 is controlled based on the command signal detected at step S20. In the present embodiment, because the “DOWN” button is operated, the control unit 30 rotates the magnifying mirror 24 in the DOWN direction by a predetermined rotation angle. As shown in FIG. 4, the magnifying mirror 24 rotates in a direction such that the angle measured between the magnifying mirror 24 and the front windshield 40 becomes greater.

At step S40, a target rotation angle of the plane mirror 14 for making the display condition of the virtual image 12c better is determined, by using a relation (or a map) shown in FIG. 6, based on the rotation angle of the magnifying, mirror 24 rotated at step S30. In the present embodiment, because the rotation angle of the magnifying mirror 24 is changed from an initial position in the DOWN direction by a predetermined angle, the rotation angle of the plane mirror 14 is also changed from an initial position of the plane mirror 14 in the DOWN direction by a predetermined angle.

At step S50, the control unit 30 transmits the command signal to the control unit 22 of the adjuster 16 such that the rotation angle of the plane. mirror 14 is caused to coincide with the target rotation angle determined at step S40. When the control unit 22 receives the command signal, the control unit 22 controls the drive portion 18 to rotate the plane mirror 14. In the present embodiment, the plane mirror 14 rotates in a direction such that the upper side of the plane mirror 14 moves away from the magnifying mirror 24.

When the procedure in step S50 is executed, and the magnifying mirror 24 is rotated, the output-side optical path of the magnifying mirror 24 relative to the front windshield 40 erroneously shifts, and the display condition of the virtual image 12c may change. However, the adjuster 16 rotates the plane mirror 14 synchronously with the rotation of the magnifying mirror 24 such that the output-side optical path of the plane mirror 14 relative to the magnifying mirror 24 is adjusted. Thereby, the erroneously shifted output-side optical path of the magnifying mirror 24 is adjusted. As a result, the display condition of the virtual image 12c is improved, and thus, the virtual image 12c, the erroneous inclination of which has been corrected, is appropriately displayed on the front windshield 40.

At step S60, it is determined whether the operation switch 32 is operated at timing of ending the process at step S50. The detection method is similar to that in step S10. When it is determined at step S60 that the operation switch 32 has been operated even after the process at step S50 has ended, control return, to step S20. While the occupant keeps operating, for example, the “DOWN” button of the operation switch 32, process from step S20 to step S50 of the control flow is repeated.

When the operation switch 32 is not operated, it is estimated that the occupant finishes adjusting the projection position of the image 12b, and thereby the control flow is ended in a state, where the rotation angles of the magnifying mirror 24 and the plane mirror 14 are maintained.

As described above, the plane mirror 14 is provided with the adjuster 16 such that the display condition of the virtual image 12c, which has been deteriorated due to the operation of the position changer 26, is effectively adjusted. Also, because the adjuster 16 is provided to the plane mirror 14, which has a relatively simple structure compared with other apparatus (the image output device 12, the magnifying mirror 24), it is possible to suppress the large increase in the cost of the HUD apparatus 10.

### Other Embodiment

Multiple embodiments of the present invention has been described as above. The present invention is not limited to the above embodiments, but may be applicable to various embodiments provided that the various embodiments do not deviate from the gist of the present invention.

For example, in the first embodiment, although the adjuster 16 has the drive portion 18 and the drive portion 20 that are electrically operable, the adjuster 16 may be alternatively provided with a threaded mechanism that is manually adjustable.

Also, in the second embodiment, although the control unit 30 transmits the command signal to the control unit 22 when the plane mirror 14 is rotated, the control unit 30 may directly control the drive portion 18, alternatively.

In the first and second embodiments, the adjuster 16 rotates the plane mirror 14 about the rotation axes 14b, 14c to change the rotational position of the reflective surface 14a. The position change of the plane mirror 14 is not limited to the rotation about the rotation axes 14b, 14c. For example, the plane mirror 14 may be moved in parallel with both predetermined two axes (X-axis, Y-axis). In case of moving the plane mirror 14 in parallel with the two axes, for example, the housing 36 may be provided with rails, which extend along X-axis and Y-axis, and the plane mirror 14 may be moved along the rails.

Additional advantages and modifications will readily occur to those skilled in the art. The invention in its broader terms is therefore not limited to the specific details, representative apparatus, and illustrative examples shown and described.

What is claimed is:

1. A head-up display apparatus comprising:
an image output device configured to output an image; and
an optical system that projects the image outputted from the image output device to a windshield of a vehicle in order to display a virtual image within the vehicle, wherein:
the optical system includes:
a first optical member receiving the image outputted from the image output device and reflecting the received image, the first optical member having an optical path, along which the image reflected by the first optical member travels; and
a second optical member receiving the image reflected by the first optical member and projecting the received image to the windshield by reflecting the received image, the second optical member having an optical path, along which the image reflected by the second optical member travels;
the second optical member has a position changer that rotates the second optical member within a predetermined rotation angle in order to change the optical path of the second optical member relative to the windshield such that a projection position of the image reflected by the second optical member on the windshield is changed; and
the first optical member has an adjuster that changes a position of the first optical member in order to adjust the optical path of the first optical member relative to the second optical member such that the optical path of the second optical member relative to the windshield is adjusted.

2. The head-up display apparatus according to claim 1, wherein:
when the position changer fixes the second optical member at a certain position within the predetermined rotation angle, the adjuster is capable of changing the position of the first optical member; and
when the adjuster fixes the position of the first optical member, the position changer is capable of rotating the second optical member.

3. The head-up display apparatus according to claim 1, wherein:
when the position changer rotates the second optical member, the adjuster changes the position of the first optical member synchronously with the rotation of the second optical member.

4. The head-up display apparatus according to claim 1, wherein:
the position changer has an operation switch operated by an occupant and generating a signal in accordance with an operation by the occupant; and
the position changer rotates the second optical member in a direction in accordance with the signal generated by the operation switch.

5. The head-up display apparatus according to claim 1, wherein:
the first optical member has two rotation axes, about each of which the first optical member is rotatable; and
the adjuster causes the first optical member to rotate about at least one of the two rotation axes in order to change the position of the first optical member.

6. The according to claim 1 head-up display apparatus, wherein the first optical member is a plane mirror.
